(19) United States
(12) Patent Application Publication
(10) Pub. No.: US 2026/0060269 A1
(43) Pub. Date: Mar. 5, 2026

(54) COLD DRINK MACHINE WITH WASHABLE FREEZING CYLINDER

(71) Applicant: Guangzhou Xin'an Trading Co., Ltd., Guangzhou (CN)

(72) Inventor: Quan Zhou, Guangzhou (CN)

(21) Appl. No.: 19/080,917

(22) Filed: Mar. 16, 2025

(30) Foreign Application Priority Data
Aug. 29, 2024 (CN) 202422119009.6
Sep. 5, 2024 (CN) 202422184814.7

(51) Int. Cl. A23G 9/12; A23G 9/04; A23G 9/22; A23G 9/28; A23G 9/30

(52) U.S. Cl. CPC A23G 9/12; A23G 9/045; A23G 9/222; A23G 9/281; A23G 9/30

(57) ABSTRACT

A cold drink machine with a washable freezing cylinder includes a housing, a freezing cylinder, a feeding assembly, a dispensing assembly, a driver mounting frame, a driver, a stirrer, and a refrigeration assembly. The feeding assembly is arranged at a rear end of the freezing cylinder, the dispensing assembly is detachably arranged at a front end of the freezing cylinder, the driver mounting frame is arranged on the feeding assembly, the driver is mounted on the driver mounting frame, and the stirrer is installed at a drive end of the driver.

### CROSS REFERENCE TO RELATED APPLICATIONS

The present application claims the benefit of Chinese Patent Application Nos. 2024221190096 filed on Aug. 29, 2024 and 2024221848147 filed on Sep. 5, 2024, the contents of which are incorporated herein by reference in their entirety.

### TECHNICAL FIELD

The present disclosure relates to the field of cold drink machines, and in particular to a cold drink machine with a washable freezing cylinder.

### BACKGROUND ART

Cold drink machines, generally including slush machines or ice cream machines, are used to produce frozen desserts such as slushies or ice cream. These machines are equipped with a freezing cylinder, which serves as the direct production container for the frozen treats. The performance and structure of the freezing cylinder are crucial. Traditional freezing cylinders typically adopt a welded construction, where multiple components are welded together to form a complete freezing chamber. However, this welded construction inevitably leaves fine welding gaps on the surface of the cylinder. During the production of frozen treats, these gaps become potential hiding spots for ingredients. Since cold drink ingredients contain various components such as fats and sugars, they are prone to condense and accumulate in these gaps, making it difficult to thoroughly clean them during the subsequent cleaning process. This, in turn, increases the difficulty and cost of cleaning.

### SUMMARY

It is desirable to provide a cold drink machine with a washable freezing cylinder, which allows for the resolution of at least one or more of the above-mentioned deficiencies in traditional cold drink machines.

According to some embodiments, the cold drink machine includes a housing, a freezing cylinder, a feeding assembly, a dispensing assembly, a driver mounting frame, a driver, a stirrer, and a refrigeration assembly. The freezing cylinder, the feeding assembly, the driver mounting frame, the driver, the stirrer, and the refrigeration assembly are arranged inside the housing, and the dispensing assembly is arranged outside the housing; the freezing cylinder is arranged along a length direction of the housing, and the freezing cylinder is integrally formed; the feeding assembly is arranged at a rear end of the freezing cylinder to deliver drink ingredients into the freezing cylinder; the dispensing assembly is detachably arranged at a front end of the freezing cylinder to dispense frozen drinks outside the freezing cylinder; and the driver mounting frame is arranged on the feeding assembly, the driver is mounted on the driver mounting frame, the stirrer is installed at a drive end of the driver and is located inside the freezing cylinder, and the refrigeration assembly is configured to lower a temperature inside the freezing cylinder to a required frozen drink production temperature.

According to some embodiments, the feeding assembly includes a delivery tube, a first mounting frame, and a first sealing ring, the rear end of the freezing cylinder is provided with a first opening, the delivery tube has an input end and an output end, and the housing is provided with a feeding port at its top; the first sealing ring is arranged at the first opening, and the first mounting frame is installed at the rear end of the freezing cylinder; and the delivery tube is fixed to the first mounting frame, and an input end of the delivery tube in communication with the feeding port and an output end in communication with the first opening.

According to some embodiments, the feeding assembly includes a second sealing ring, and the rear end of the freezing cylinder is provided with a second opening; and the second sealing ring is arranged at the second opening, the driver mounting frame is installed on the first mounting frame, and the drive end of the driver extends through the second opening.

According to some embodiments, the dispensing assembly includes a dispensing plate, a second mounting frame, an operating handle, a pivot shaft, a torsion spring, a linkage arm, and a stopper; the front end of the freezing cylinder is provided with a third opening, a front side of the housing is provided with a first dispensing port, and the dispensing plate is provided with a second dispensing port; the third opening is in communication with the first dispensing port, the dispensing plate is arranged at the first dispensing port, and the second mounting frame is mounted on the dispensing plate; the operating handle is pivotally mounted on the second mounting frame via the pivot shaft, enabling the operating handle to swing up and down; one end of the torsion spring is connected to the pivot shaft, and the other end is connected to the stopper, and one end of the linkage arm is connected to the operating handle, and the other end is connected to the stopper; and the stopper is configured to block the second dispensing port when the operating handle swings upward, and to open the second dispensing port when the operating handle swings downward.

According to some embodiments, the cold drink machine includes a support frame. The support frame is disposed inside the housing, and a lower part of the driver is mounted on the support frame.

According to some embodiments, the cold drink machine includes a support tray. The support tray is mounted on a front outer side of the housing and positioned below the dispensing assembly.

In various embodiments of the present disclosure, the integrally formed freezing cylinder is provided inside the housing and works in conjunction with the driver, the stirrer, and the refrigeration assembly to process the drink ingredients inside the freezing cylinder into the frozen drinks. In some examples, the freezing cylinder is integrally formed through stamping. Compared with traditional freezing cylinders made by welding multiple components, the integrally formed freezing cylinder eliminates welding gaps on its surface, preventing drink ingredient residues from accumulating in such gaps. This design facilitates thorough cleaning of the freezing cylinder, reducing both the difficulty and cost of cleaning. During cleaning, the freezing cylinder can be easily accessed by simply detaching the dispensing assembly from its front end.

### BRIEF DESCRIPTION OF THE DRAWINGS

FIG. 1 is a partial schematic diagram of the structure of a cold drink machine with a washable freezing cylinder according to embodiments of the present disclosure.

FIG. 2 is an exploded view of an embodiment of the cold drink machine of the present disclosure.

FIG. 3 is an exploded view of an embodiment of the cold drink machine of the present disclosure.

FIG. 4 is an exploded view of an embodiment of the cold drink machine of the present disclosure.

FIG. 5 is an exploded view of an embodiment of the cold drink machine of the present disclosure.

### DETAILED DESCRIPTION

The technical solution of the present disclosure will be further described in detail in conjunction with the accompanying drawings and various embodiments.

In the description of the present disclosure, it should be appreciated that the terms such as “length,” “middle,” “upper,” “lower,” “left,” “right,” “top,” and “bottom” indicate positional or directional relationships based on the orientations shown in the accompanying drawings. These terms are used solely for the convenience of describing the present disclosure and simplifying the description, rather than implying that the referenced devices or elements must have a specific orientation, be constructed, or operate in a particular manner. Therefore, these terms should not be construed as limitations to the present disclosure.

In addition, the terms “first” and “second” are used solely for descriptive purposes and should not be construed as indicating or implying relative importance or implicitly specifying the number of the referenced technical features. Thus, features indicated by “first” and “second” may explicitly or implicitly include one or more of such features. In the description of the present disclosure, unless otherwise specified, the term “multiple”means two or more.

In the description of the present disclosure, it should be noted that, unless otherwise explicitly specified and defined, the terms “mount,” “engage,” and “connect” should be understood in a broad sense. For example, they may refer to fixed connections, detachable connections, or integral connections; they may indicate direct connections or indirect connections through an intermediate medium; they may also refer to internal communication between two components. Those skilled in the art can understand the specific meanings of these terms in the present disclosure based on specific circumstances.

Various embodiments provide a cold drink machine with a washable freezing cylinder, including a housing 1, a freezing cylinder 2, a feeding assembly 3, a dispensing assembly 4, a driver mounting frame 5, a driver 6, a stirrer 7, and a refrigeration assembly 8. The freezing cylinder 2, the feeding assembly 3, the driver mounting frame 5, the driver 6, the stirrer 7, and the refrigeration assembly 8 are arranged inside the housing 1, while the dispensing assembly 4 is arranged outside the housing 1. The freezing cylinder 2 is arranged along the length direction of the housing and is integrally formed. The feeding assembly 3 is arranged at the rear end of the freezing cylinder 2 to deliver drink ingredients into the freezing cylinder 2. The dispensing assembly 4 is detachably arranged at the front end of the freezing cylinder 2 to dispense frozen drinks outside the freezing cylinder 2. The driver mounting frame 5 is arranged on the feeding assembly 3, and the driver 6 is mounted on the driver mounting frame 5. The stirrer 7 is installed at a drive end of the driver 6 and is located inside the freezing cylinder 2. The refrigeration assembly 8 is configured to lower the temperature inside the freezing cylinder 2 to the required frozen drink production temperature.

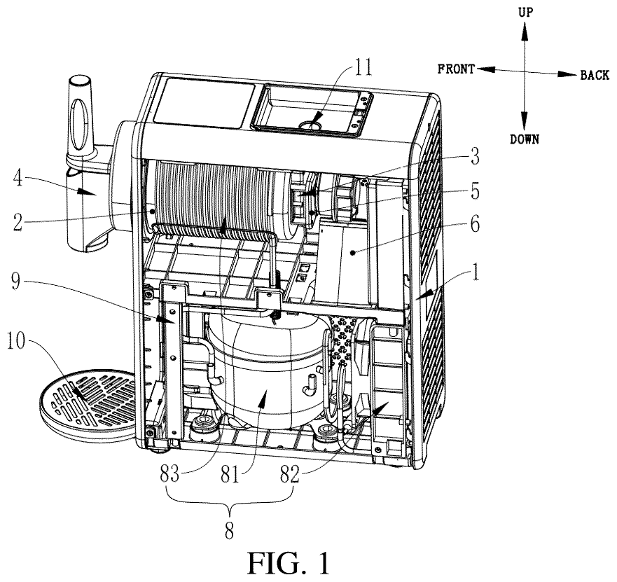

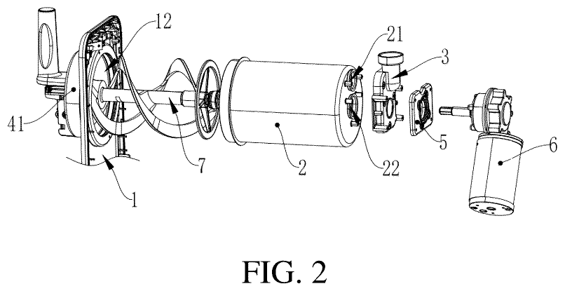

In some examples, the cold drink machine is an ice cream machine or a slush machine. As shown in FIGS. 1-2, when making a cold drink, the operator first feeds the drink ingredients into the freezing cylinder 2 through the feeding assembly 3 and then starts the driver 6. In some examples, the driver 6 is a motor. The driver 6 drives the stirrer 7 to rotate, and under the action of the refrigeration assembly 8, the temperature inside the freezing cylinder 2 is lowered to the required frozen drink production temperature. The rotation of the stirrer 7 ensures that the drink ingredients inside the freezing cylinder 2 are thoroughly mixed and evenly cooled, resulting in the formation of the frozen drinks. Finally, the frozen drinks are dispensed outside the freezing cylinder 2 through the dispensing assembly 4. The arrangement of the driver mounting frame 5 facilitates the installation and fixation of the driver 6.

According to some embodiments, the refrigeration assembly 8 has a conventional structure, and the refrigeration assembly 8 includes a compressor 81, a condenser 82, and an evaporator 83. The evaporator 83 is mounted on the surface of the freezing cylinder 2. The compressor 81, the condenser 82, and the evaporator 83 work together, with the refrigerant circulating among them to lower the temperature inside the freezing cylinder 2.

According to some embodiments, the integrally formed freezing cylinder 2 is provided inside the housing 1 and works in conjunction with the driver 6, the stirrer 7, and the refrigeration assembly 8 to process the drink ingredients inside the freezing cylinder 2 into the frozen drinks. In some examples, the freezing cylinder 2 is integrally formed through stamping. Compared with traditional freezing cylinders made by welding multiple components, the integrally formed freezing cylinder 2 eliminates welding gaps on its surface, preventing drink ingredient residues from accumulating in such gaps. This design facilitates thorough cleaning of the freezing cylinder, reducing both the difficulty and cost of cleaning. During cleaning, the freezing cylinder 2 can be easily accessed by simply detaching the dispensing assembly 4 from its front end.

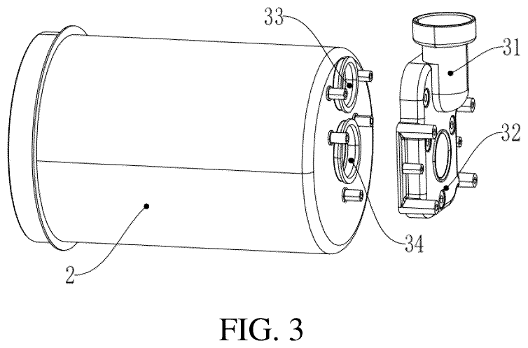

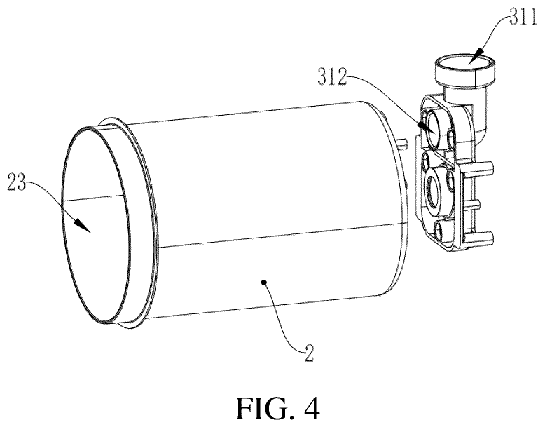

In some embodiments, as shown in FIG. 3, the feeding assembly 3 includes a delivery tube 31, a first mounting frame 32, and a first sealing ring 33. Referring to FIGS. 1-4, the rear end of the freezing cylinder 2 is provided with a first opening 21; the delivery tube 31 has an input end 311 and an output end 312, and the top of the housing 1 is provided with a feeding port 11; the first sealing ring 33 is arranged at the first opening 21, and the first mounting frame 32 is installed at the rear end of the freezing cylinder 2; the delivery tube 31 is fixed to the first mounting frame 32, with its input end 311 in communication with the feeding port 11 and its output end 312 in communication with the first opening 21.

The arrangement of the first sealing ring 33 ensures the sealing of the first opening 21, preventing the drink ingredients from leaking outside the freezing cylinder 2 or external impurities from entering its interior. Additionally, during the cleaning process, the first sealing ring helps prevent wash water from leaking out of the first opening 21 to the exterior of the freezing cylinder 2. The arrangement of the first mounting frame 32 provides support and fixation for the delivery tube 31, such that the delivery tube 31 is securely mounted on the freezing cylinder 2. Since the input end 311 of the delivery tube 31 is in communication with the feeding port 11 and the output end 312 is in communication with the first opening 21, the delivery tube 31 enables the drink ingredients to be transported from the feeding port 11 into the freezing cylinder 2.

In some embodiments, as shown in FIGS. 2-3, the feeding assembly 3 includes a second sealing ring 34, and the rear end of the freezing cylinder 2 is provided with a second opening 22. The second sealing ring 34 is arranged at the second opening 22. The driver mounting frame 5 is installed on the first mounting frame 32, and the drive end of the driver 6 extends through the second opening 22.

The arrangement of the second sealing ring 34 ensures the sealing at the connection point between the drive end of the driver 6 and the freezing cylinder 2, preventing the drink ingredients from leaking. Additionally, during the cleaning process, the second sealing ring helps prevent wash water from leaking through the second opening 22, thereby protecting the driver 6 from any potential impact. Since the driver mounting frame 5 is installed on the first mounting frame 32, the arrangement of the first mounting frame 32 also provides support for the driver mounting frame 5.

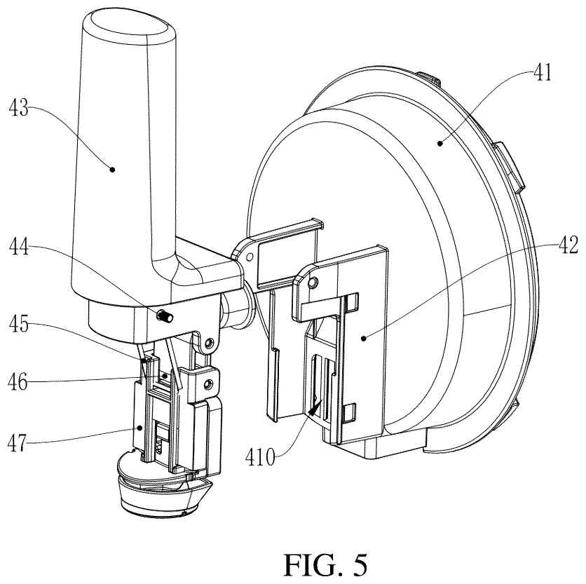

In some embodiments, as shown in FIG. 5, the dispensing assembly 4 includes a dispensing plate 41, a second mounting frame 42, an operating handle 43, a pivot shaft 44, a torsion spring 45, a linkage arm 46, and a stopper 47. The front end of the freezing cylinder 2 is provided with a third opening 23, the front side of the housing 1 is provided with a first dispensing port 12, and the dispensing plate 41 is provided with a second dispensing port 410. The third opening 23 is in communication with the first dispensing port 12. The dispensing plate 41 is arranged at the first dispensing port 12, and the second mounting frame 42 is mounted on the dispensing plate 41. The operating handle 43 is pivotally mounted on the second mounting frame 42 via the pivot shaft 44, allowing it to swing up and down. One end of the torsion spring 45 is connected to the pivot shaft 44, and the other end is connected to the stopper 47. One end of the linkage arm 46 is connected to the operating handle 43, and the other end is connected to the stopper 47. When the operating handle 43 swings upward, the stopper 47 blocks the second dispensing port 410. When the operating handle 43 swings downward, the stopper 47 opens the second dispensing port 410.

As shown in FIGS. 2 and 4-5, since the dispensing plate 41 is arranged at the first dispensing port 12, the dispensing plate 41 ensures the sealing of the freezing cylinder 2. In the initial state, the stopper 47 completely blocks the second dispensing port 410. When it is necessary to dispense the frozen drink, the operating handle 43 can be swung downward, thereby driving the linkage arm 46 to move upward. At the same time, an upward elastic force is applied to the torsion spring 45, causing the stopper 47 to move upward and unblock the second dispensing port 410. Then, the driver 6 is activated, driving the stirrer 7 to stir the drink ingredients inside the freezing cylinder 2. During the stirring process, the stirrer 7 pushes the drink ingredients toward the second dispensing port 410 of the dispensing plate 41, allowing the final frozen drink to be dispensed through the second dispensing port 410.

According to some embodiments, as shown in FIG. 1, the cold drink machine includes a support frame 9, which is disposed inside the housing 1. The lower part of the driver 6 is mounted on the support frame 9. The support frame 9 provides structural support for the driver 6, further enhancing its stability during installation.

According to some embodiments, as shown in FIG. 1, the cold drink machine includes a support tray 10, which is mounted on the front outer side of the housing 1 and positioned below the dispensing assembly 4. The support tray 10 facilitates the placement of containers for receiving the frozen drinks and helps prevent them from dripping onto the floor.

The technical principles of the present disclosure have been described in conjunction with various embodiments. These descriptions are provided solely to explain the principles of the present disclosure and should not be construed in any way as limiting the scope of protection. Based on these explanations, those skilled in the art can conceive of other embodiments of the present disclosure without requiring inventive effort, and such embodiments shall fall within the scope of protection of the present disclosure.

What is claimed is:

1. A cold drink machine with a washable freezing cylinder, comprising a housing, a freezing cylinder, a feeding assembly, a dispensing assembly, a driver mounting frame, a driver, a stirrer, and a refrigeration assembly,
wherein the freezing cylinder, the feeding assembly, the driver mounting frame, the driver, the stirrer, and the refrigeration assembly are arranged inside the housing, and the dispensing assembly is arranged outside the housing;
wherein the freezing cylinder is arranged along a length direction of the housing, and the freezing cylinder is integrally formed;
wherein the feeding assembly is arranged at a rear end of the freezing cylinder to deliver drink ingredients into the freezing cylinder;
wherein the dispensing assembly is detachably arranged at a front end of the freezing cylinder to dispense frozen drinks outside the freezing cylinder; and
wherein the driver mounting frame is arranged on the feeding assembly, the driver is mounted on the driver mounting frame, the stirrer is installed at a drive end of the driver and is located inside the freezing cylinder, and the refrigeration assembly is configured to lower a temperature inside the freezing cylinder to a required frozen drink production temperature.

2. The cold drink machine according to claim 1, wherein the feeding assembly includes a delivery tube, a first mounting frame, and a first sealing ring, the rear end of the freezing cylinder is provided with a first opening, the delivery tube has an input end and an output end, and the housing is provided with a feeding port at its top;
wherein the first sealing ring is arranged at the first opening, and the first mounting frame is installed at the rear end of the freezing cylinder; and
wherein the delivery tube is fixed to the first mounting frame, and an input end of the delivery tube in communication with the feeding port and an output end in communication with the first opening.

3. The cold drink machine according to claim 2, wherein the feeding assembly includes a second sealing ring, and the rear end of the freezing cylinder is provided with a second opening; and
wherein the second sealing ring is arranged at the second opening, the driver mounting frame is installed on the first mounting frame, and the drive end of the driver extends through the second opening.

4. The cold drink machine according to claim 1, wherein the dispensing assembly includes a dispensing plate, a second mounting frame, an operating handle, a pivot shaft, a torsion spring, a linkage arm, and a stopper;
wherein the front end of the freezing cylinder is provided with a third opening, a front side of the housing is provided with a first dispensing port, and the dispensing plate is provided with a second dispensing port;
wherein the third opening is in communication with the first dispensing port, the dispensing plate is arranged at the first dispensing port, and the second mounting frame is mounted on the dispensing plate;
wherein the operating handle is pivotally mounted on the second mounting frame via the pivot shaft, enabling the operating handle to swing up and down;
wherein one end of the torsion spring is connected to the pivot shaft, and the other end is connected to the stopper, and one end of the linkage arm is connected to the operating handle, and the other end is connected to the stopper; and
wherein the stopper is configured to block the second dispensing port when the operating handle swings upward, and to open the second dispensing port when the operating handle swings downward.

5. The cold drink machine according to claim 1, further comprising a support frame, wherein the support frame is disposed inside the housing, and a lower part of the driver is mounted on the support frame.

6. The cold drink machine according to claim 1, further comprising a support tray, wherein the support tray is mounted on a front outer side of the housing and positioned below the dispensing assembly.
